(19) United States
(12) Patent Application Publication
(10) Pub. No.: US 2006/0025301 A1
(43) Pub. Date: Feb. 2, 2006

(54) Process for preparing nanosized, thermally stable, and high surface area multi-component metal oxides

(76) Inventors: Benjaram Mahipal Reddy, Hyderabad (IN); Ataullah Khan, Hyderabad (IN); Pavani Maruthi Sreekanth, Hyderabad (IN); Pandian Lakshmanan, Hyderabad (IN)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/909,261

(22) Filed: Jul. 30, 2004

(51) Int. Cl. B01J 23/10

(52) U.S. Cl. 502/304

(57) ABSTRACT

The present invention relates to a method for producing nanosized, thermally stable, and high surface area multicomponent metal oxides and the metal oxide products have been found to retain a high specific surface area, with particle size ranging from 3-10 nanometers even after subjecting them to elevated temperatures, which make them ideally suited for use as catalysts and catalytic carrier materials.

### FIELD OF THE INVENTION

The invention relates to a method of making nanosized multi-component metal oxides by taking one metal oxide component among the components of the composite mixed oxides as a support in the dispersed form in a liquid and the oxide components that have to be supported are taken as precursor salts in the same container as a solution form. The precursors dispersed in water are deposited on the support oxide by precipitating them onto the surface of support oxide as hydroxides and calcining them later. The obtained metal oxides are useful as catalyst materials and catalyst carriers.

### BACKGROUND OF THE INVENTION

Certain applications, such as catalysis and adsorption, require metal oxides which have higher surface areas. While many techniques exist to produce such high surface area materials (e.g., precipitation methods, sol-gel techniques, spray pyrolysis, etc.), all are limited in their ability to produce support materials, which retain their high surface area after extended thermal treatments at higher temperatures. Automotive exhaust catalysts, in particular, require metal oxide support materials for both the active noble metals and other metal additives. Typically metal oxides such as ceria, or ceria mixed with other oxides such as zirconia, praseodymia, and lanthana are also used in automotive catalyst formulations as oxygen storage components because of their ability to supply oxygen for converting pollutant species such as carbon monoxide, hydrocarbons and NOx through a cyclic reduction-oxidation process.

It has been known that supported ceria-zirconia mixed oxides exhibit better catalytic properties retaining the stability in terms of surface area and various phases of ceria-zirconia mixed oxides. Alumina supported ceria-zirconia systems are integral part of the so-called three way catalysts and involve the cutting edge technology of automotive catalysis. Here the Ce—Zr promoter/carrier (alumina) interface may be an additional factor affecting the surface energy and improving the stability of the supported mixed oxide phases of ceria-zirconia. It has been shown by Kaspar et al [J. Solid State Chem., 171, 2003, 19-29] that the most important effect of deposition of ceria-zirconia on alumina is certainly to increase in thermal stability of the Ce—Zr mixed oxides compared to that of unsupported ones. They attributed to either a synergic stabilization between alumina and Ce—Zr oxide phases or to the retarding effect of alumina on the sintering rate of the supported ceria-zirconia phase. A particle size of 6 nm was detected after harsh conditions, which is far below the critical size of 15-20 nm that was suggested as a limiting value above which the mixed oxide tends to segregate. For comparison, particle size as large as 20 nm are easily detected after 5 h calcination at 1273 K of unsupported ones. This result clearly illustrates the importance of nano-structuring of the composite oxides.

High specific surface area is a desirable property for materials such as supported ceria-zirconia systems based on the reason that these catalytic materials have wide range of applicability in various fields. In automotive catalysis, the metal oxide support phases also have the desirable characteristic of aiding in the dispersion of the active noble metals as very small particles (typically 5 nm or less when fresh). However, automotive catalysts are often subjected to very high operating temperatures which, over time, result in growth (i.e., sintering) of both the noble metals and the underlying metal oxide support phase with concomitant loss of surface area. Similarly, the property of oxygen storage, which is a cooperative phenomenon between the reducible metal oxide and the noble metals, also decreases dramatically upon sintering of the noble metal and metal oxide materials. Consequently, it is desirable to produce metal oxide materials, suitable as both support phases and oxygen storage agents, which can be used in automotive exhaust and other catalytic applications where temperatures can exceed 1323 K, without the surface area decreasing. Additionally, for automotive catalysis, it is desirable to produce supporting oxides with a nanostructure largely in the 10 nm regime. Furthermore, ceria-zirconia mixed oxides are finding extensive applications including catalytic combustion of hydrocarbons, carbon monoxide oxidation, oxidation of volatile organic compounds, water gas shift reaction, dehydration of alcohols, steam reforming of ethanol, oxygen permeation membrane systems, and fuel cell technologies. The small size allows stabilization of mixed oxides of cerium and zirconium and resulting in high surface area, for easy access of the reacting gases to the catalyst surface. The present invention has been found to meet those objectives through the use of a support material, which can impart desirable thermal stability and high surface area to the resultant metal oxide powders.

### SUMMARY OF THE INVENTION

This invention is a method for making nanosized, thermally-stable, high-surface-area, metal oxide materials, the steps of the method comprising: combining the liquid solutions of metal oxide precursor salts with a liquid dispersion of a metal oxide in the form of metal oxide powder; stirring vigorously the obtained mixture; converting the metal oxide precursors to metal oxides by depositing the metal precursors onto the support metal oxide by precipitating the metal components by changing the pH of the mixture; aging the obtained material for a certain time; calcining the resultant material, and depositing the active component oxide by dispersing the calcined material in aqueous solution containing the precursor of the active metal/metal oxide component; removing excess water to get final product of the composite metal oxide.

Metal oxide powders of the present invention advantageously have been shown to retain their nanosize, resistant to sintering and maintain high surface area even after thermal treatments at approximately 1073 K or higher. Such powders are useful as high surface area catalyst materials, particularly as supporting phases for noble metals and transition metal oxides for various catalytic applications.

### DETAILED DESCRIPTION OF THE INVENTION

Accordingly, the present invention deals with a process for preparing nanosized, thermally stable and high-surface-area multi-component metal oxide materials, the said process comprising the steps:
i) dispersing two precursors of metal salts and a support metal oxide in a medium in a ratio in the range of 1:1: to 1:1:2;
ii) precipitating the dispersed precursor metal salts on to support metal oxide to obtain a precipitate, and
iii) calcinating the precipitate of step (ii) to obtain the multi-component metal oxide.

In another embodiment of the present invention the said support metal oxide is selected from the group consisting of titania, silica, and alumina.

Still in another embodiment of the present invention the said support metal oxide is in the form of fine powder which can give rise to high surface area and retain thermal stability. Further in another embodiment of the present invention the precursors metal salts are selected from the group consisting of cerium, zirconium, alkaline earth elements and mixtures thereof.

In one more embodiment of the present invention the precursor metal salts are selected from the group consisting of nitrates, chlorides, oxychlorides and mixtures thereof.

In another embodiment of the present invention the medium is water.

Yet in another embodiment of the present invention the precipitation of pre-cursor metal salts onto the said metal oxide support is carried out by increasing the pH at a temperature in the range of 293-368° K.

Still in another embodiment of the present invention the pH is raised to more than 10.5.

In another embodiment of the present invention the composite metal oxide materials retain surface area in excess of 50 m²/g after air-calcination for 6-8 hours at about 1073° K.

Yet in another embodiment of the present invention the metal oxide materials retain crystallite size up to the 5 nanometers after air-calcination for 6-8 hours at about 1073° K.

In one more embodiment of the present invention the multiple metal oxide material is further coated with noble metal/metal oxide.

Further, in another embodiment of the present invention the coating of active metal/metal oxide is carried out by wetness impregnation of multiple metal oxide material in an aqueous solution of precursors of the active metal/metal oxide species which is selected from a group of active metals/metal oxides consisting, platinum, vanadium oxide, molybdenum oxide, and tungsten oxide.

Still one more embodiment of the present invention the wetness impregnation involves heating of the mixture of active metals/metal oxide with multiple metal oxide in aqueous solution of oxalic acid at a temperature in the range of 363-373° K, and subsequent calcination at a temperature in the range of 773-1073° K. in air or oxygen atmosphere.

Yet in another embodiment of the present invention the multicomponent metal oxide materials retain surface area in excess of 100 m²/g after calcination for 6-8 hours at 773° K. Still in another embodiment of the present invention the multicomponent metal oxide materials retain crystallite size up to 5 nanometers after air-calcination for 6-8 hours at 773° K.

The invention is a process for preparing nanosized, is thermally stable, high-surface-area metal oxide materials using unique deposition precipitation method, where one of the metal oxide components serves as a support metal oxide to other components. That metal oxide support component is capable of getting loaded at the maximum and producing high surface area materials. The metal oxide support is taken as a metal oxide powder as such and dispersed in water. The precursors of the metal oxides that have to be loaded are dispersed in the mixture of water with support metal oxide. The precursors of the metal oxides are converted into the metal oxides by precipitating them onto the support metal oxide surface by changing the pH of the medium. The resulted gel is calcined and coated with the active metal/metal oxide component by aqueous impregnation method.

A surprising and unexpected advantage of the present invention method is that the resultant multicomponent composite metal oxides so produced have been found to have smaller particles in the range of few manometers, show good thermal stability, exhibit high resistance to sintering and low particle size even though the loading was extremely high. Commonly used techniques for making porous metal oxides such as colloidal methods, sol-gel methods, microemulsion and molecular templating techniques are capable of producing materials with comparable, or even greater, surface area at low temperatures. However, the current invention is unique in its ability to produce materials with very high loadings, in large quantities but with particle size in few nanometer range with higher surface area after heating at elevated temperatures up to 1073 K. That is, in the present invention metal oxides retain their particle size within few nanometers and high surface area at elevated temperatures, which is a desirable and critical property for use as catalysts and catalyst supports.

According to the present invention, suitable metal oxide precursors of the desired metal oxide or mixed oxide (in case of the so-called support oxide onto which other metal oxide components have to be deposited) are first selected and dispersed in a solution. The metal oxide precursors may be selected from any precursor, which will provide a metal or a metal compound on the support metal oxide material, which metal or compound is capable of converting to its metal oxide during the subsequent calcination of the material. The metals can be supplied via any salts that are soluble in the solvent. Nitrates are particularly suitable since they generally show good solubility in aqueous solution. Other common precursors, which have been successfully used, include inorganic salts such as chlorides, oxychlorides and other salts of high solubility in water. The metal may be any and includes, e.g., but is not limited to, cerium, zirconium, aluminum, and lanthanum, and virtually all of the elements of the alkaline earth, transition metal, and lanthanide metal series of the periodic table, and mixtures of any such metals. Still other metal oxide precursors will be apparent to those skilled in the art in view of the present disclosure. It is particularly desired to manufacture oxides of metals like cerium and zirconium, aluminum, silicon, and titanium according to the present invention if the resultant metal oxides are to be used as catalyst supports. The metal oxides of the present invention may be used, however, as other than a catalyst support due to their both high surface area and its stability at elevated temperatures, for example, oxidation of carbon monoxide, dehydration of alcohols, catalytic combustion of hydrocarbons and other oxidation processes. In different cases, the metal oxide may also be selected from a broad range of alkaline earth, transition, or lanthanide elements.

The water is the most convenient and preferred solvent. The volume of water is taken in a wide range 0.5 to 8 liters or more. The effective stirring of the mixture solution is compulsory whatever may be the total volume of the reaction mixture. Thorough dispersion of the support metal oxide is crucially important before adding the precipitating reagent

For the 1:1 ratio of cerium-zirconium oxides, the ratio of support oxide to the metal oxides that have to be supported is varied from 1:1:1 to 1:1:2. Very interestingly, one of the advantages of this method of preparation is that even with the highest loading on the support metal oxide, still composite oxides with particle size in the range of few nanometers can be achieved leading to high surface areas. The extent of dilution of the mixture of metal precursor salts and the support metal oxide seems to be an important controlling factor affecting the particle size and the characteristics of the materials obtained.

Deposition can be carried out at any temperature below the boiling point of water preferably in the range of 313-323 K. The time taken for the completion of deposition precipitation is also varied from 1 to 16 hours and it was observed that best results could be obtained at about 2-3 hours. The effect of aging times also seems to have some influence on the nature of the resulting materials and three days aging of the mixtures of precipitated material seems to be sufficient for all the cases investigated.

After the calcination step, the synthesis of the oxide materials according to the essential steps of the invention is essentially complete. The obtained the materials were further coated with metals/metal oxides by aqueous wet impregnation method. For example to make V₂O₅/CeO₂—ZrO₂/TiO₂ composite oxides, ammonium metavanadate was dissolved in aqueous solution of oxalic acid (0.2 M) to which 773 K calcined CeO₂—ZrO₂/TiO₂ was added in fine powder form. The resulting mixture was dried on a water-bath to remove excess water, and subsequently oven dried at 383 for 12 hours, and finally calcined at 773 K for 6 hrs in flowing oxygen atmosphere. In the preferred embodiment as a component of automotive exhaust catalysts, the material is having high suitability for coating with salts of noble metals, usually from the group of platinum, palladium, and rhodium. Other surface additives from the transition element series, alkaline earth element series, or rare earth element series might also be added to further promote thermal stability, catalytic activity, and oxygen storage capacity, in combinations familiar to those skilled in the art. Such components of three-way automotive catalysts are particularly suitable for use in catalytic converters, which experience very high temperatures during use, and consequently, require extremely good thermal stability.

Conventional methods of producing metal oxides include techniques such as precipitation (or co-precipitation) of metal salts from solution, or direct decomposition of hydrated nitrate salts. These techniques generally produce low surface area, dense oxide powders with bigger particle size. The approach of the present invention retains the simplicity of the conventional techniques but produces material of much higher surface area and smaller particle size. Other methods are also available for producing high-surface-area metal oxides. These include sol-gel, spray pyrolysis, and molecular templating approaches. However, each method has disadvantages compared to the present invention, and none was found by us to be capable of producing materials with high loading of the binary metal oxide solid solutions supported onto the support metal oxide, such as silica, alumina, and titania with a nanorange of the particles.

The preparation of supported ceria-zirconia solid solution has been carried out using co-impregnation method, sol-gel, and micro-emulsion methods using alumina as a support oxide. Compared to those methods the present invention has the advantage that production of catalytic materials in both higher loadings and in large quantities is made possible owing to the nature and simplicity of the synthesis methodology.

The significant advantage of the present method is its ability to produce nanosized materials with particle size within 10 nanometers for even high loadings of mixed oxides that have to be supported onto the surface of a third metal oxide. Furthermore, support metal oxides other than alumina have not been considered in the literature. In the case of lower loading of ceria-zirconia materials the disadvantages arising from incomplete incorporation of zirconium into the ceria lattice, formation of two dimensional patches and three dimensional entities, on the alumina support, and selective interaction of one of the components of ceria-zirconia mixed oxides with the alumina support, for example, formation of cerium aluminate were encountered. On the contrary, higher loadings of ceria-zirconia component eliminates the possibility of two dimensional patches and three dimensional entities, and preventing the formation of selective interaction products, such as zirconium titanate, in the case of corresponding ternary oxide systems (Ce—Zr/M and M=Ti) equivalent thermal stability to that achieved with the present invention. For example, molecular templating generally requires synthesis of expensive and complex organic compounds as structure directing agents. Sol-gel methods require an additional precipitation step as well as the use of complex organic salts of the metal oxide precursors.

The present invention technique is also quite versatile as to the range of mixed oxide compositions, which can be produced. Quite surprisingly the present method reveals the stabilization of TiO₂ anatase phase even after calcining the titania supported ceria-zirconia, at 1073 K for 6 hours in air. In addition to excellent thermal stability, the mixed oxide materials prepared by the present method involve maintaining the fluorite structure of the mixed oxides after air-calcination up to 1073 K.

Also, when aqueous solutions are used, as is typically the case, no organic vapors are produced during the drying and calcination steps thus preventing environment concerns.

The process for the preparation of multicomponent oxides of the present invention is illustrated by the examples given below which should not however be considered to limit the scope of the invention.

### EXAMPLES

The following examples are given by way of illustration and therefore should not be construed to limit the scope of the present invention.

### Example 1

In a typical experiment to make CeO₂—ZrO₂/TiO₂ (1:1:2 mole ratio) multicomponent oxide, 12.05 g of ceric nitrate ammonium complex (Loba Chemie) and 9.431 g of zirconium (IV) nitrate (Fluka) were dissolved in double distilled water separately. A 3.512 g of TiO₂-anatase fine powder was dispersed separately in double distilled water. All three solutions were mixed thoroughly. The aqueous solution of ammonia was added drop-wise over extended periods of time (2-6 hours), to the reaction mixture to deposit the precipitates containing Ce and Zr. The obtained materials were filtered, washed, oven dried and finally calcined at 773° K. The prepared materials before and after calcination were characterized by different techniques such as differential thermal analysis, X-ray diffraction, X-ray photoelectron spectroscopy, Raman spectroscopy, high-resolution electron microscopy, specific surface area and other methods. The obtained material exhibited 105 m²/g specific surface area 3.7 nm particle size, zirconium incorporated Ce_{0.75}Zr_{0.25}O₂ cerium cubic and TiO₂-anatase phases. These materials were subjected to various treatment temperatures ranging from 773 to 1073 K. These materials fairly retained similar physicochemical properties after thermal treatments too.

### Example 2

To obtain another CeO₂—ZrO₂/TiO₂ (1:1:2 mole ratio) multicomponent oxide, a 9.542 g of cerium nitrate (Loba Chemie) and 9.431 g of zirconium (IV) nitrate (Fluka) were dissolved separately in double distilled water. Other preparation procedures are the same as in example 1 and exhibited similar physicochemical characteristics.

### Example 3

To make yet another CeO₂—ZrO₂/TiO₂ (1:1:2 mole ratio) composite oxide, 8.188 g of ceric chloride (Loba Chemie) and 9.431 g of zirconium (IV) nitrate (Fluka) were dissolved in double distilled water. Other preparation procedures are the same as in example 1.

### Example 4

In yet another experiment the CeO₂—ZrO₂/TiO₂ (1:1:2 mole ratio) composite oxide was prepared by dissolving 12.05 g of ceric nitrate ammonium complex (Loba Chemie) and 7.079 g of zirconium oxychloride (Loba Chemie) separately in double distilled water. Other preparation procedures are the same as in example 1.

### Example 5

To prepare yet another batch of CeO₂—ZrO₂/TiO₂ (1:1:2 mole ratio), 8.188 g of ceric chloride (Loba Chemie) and 7.079 of zirconium oxychloride (Loba Chemie) were dissolved separately in distilled water. Other preparation procedures are the same as in example 1.

### Example 6

To make CeO₂—ZrO₂/TiO₂ (0.75:0.25:1 mole ratio) mixed oxide, 17.148 g of 12.05 g of ceric nitrate ammonium complex (Loba Chemie) and 4.477 g of zirconium (IV) nitrate (Fluka) were dissolved separately in double distilled water. A 3.33 g of titanium oxide fine powder was dispersed in double distilled water and all three solutions were mixed thoroughly. The other procedures are same as that of example 1.

### Example 7

To make CeO₂—ZrO₂/SiO₂ (1:1:1 mole ratio), 15.43 g of ceric nitrate ammonium complex (Loba Chemie) and 12.09 g of zirconium (IV) nitrate (Fluka) were dissolved separately in double distilled water. A 1.689 g of silica fine powder was separately dispersed in double distilled water and all three solutions were mixed thoroughly. The other procedures are same as that of example 1.

### Example 8

To make 5 wt. % V₂O₅/CeO₂—ZrO₂/TiO₂ composite oxides, 0.6428 g of ammonium metavanadate was dissolved in aqueous solution of oxalic acid (0.2 M) to which 9.5 g of 773 K calcined CeO₂—ZrO₂/TiO₂ was added in fine powder form. The resulting mixture was dried on a water-bath to remove excess water, and subsequently oven dried at 383 for 12 hours, and finally calcined at 773 K for 6 hrs in flowing oxygen atmosphere. The obtained samples of vanadium oxide coated composite oxide materials exhibited a Ce_{0.75}Zr_{0.25}O₂ cubic phase with particle size of 4.0 nm, titania-anatase phase, highly dispersed vanadium oxide phase, and 85 m²/g specific surface area. The same physicochemical properties were retained even after subjecting them to various calcination temperatures up to 1073 K. At 1073 K treatment temperature, more incorporation of zirconia into ceria lattice is noted still retaining ceria cubic fluorite structure, 7-8 nm size, and 30 m²/g surface area. Also the formation of catalytically useful CeVO₄ phase is observed.

### Example 9

To make 10 wt. % V₂O₅/CeO₂—ZrO₂/TiO₂ multicomponent oxide materials, the CeO₂—ZrO₂/TiO₂ material obtained in example 1 was subjected to wet impregnation method. To load 10 wt. % V₂O₅ on the composite oxide support, 1.2856 g of ammonium metavanadate was dissolved in aqueous solution of oxalic acid (0.2 M) to which the 773 K calcined CeO₂—ZrO₂/TiO₂ was incorporated. The resulting mixture was dried on a water-bath to remove excess water, and subsequently heated at 383 for 12 hours, and calcined at 773 K for 6 hours in flowing oxygen atmosphere to get the final product. The obtained samples of vanadium oxide coated composite oxide materials exhibited Ce_{0.75}Zr_{0.25}O₂ cubic phase with particle size of 5.0 nm, titania-anatase phase, highly dispersed vanadium oxide phase. The same physicochemical properties were mostly retained even after subjecting them to various calcination temperatures up to 1073 K. At 1073 K treatment temperature, more incorporation of zirconia into ceria lattice leading to formation of Ce_{0.16}Zr_{0.84}O₂ tetragonal phase in addition to well-crystallized (8 nm) ceria cubic phase, titania-anatase phase, and CeVO₄ phase were observed.

Advantages of the Present Invention:

1. The significant advantage of the present method is its ability to produce nano-sized materials with particle size within 10 nanometers for even high loadings of mixed oxides that have to be supported onto the surface of a third metal oxide.

2. Furthermore, support metal oxides other than alumina have not been considered in the literature.

3. The present invention technique is also quite versatile as to the range of mixed oxide compositions, which can be produced. Quite surprisingly the present method reveals the stabilization of TiO₂ anatase phase even after calcining the titania supported ceria-zirconia, at 1073° K. for 6 hours in air.

4. In addition to excellent thermal stability, the mixed oxide materials prepared by the present method involve maintaining the fluorite structure of the mixed oxides after air-calcination up to 1073° K.

We claim:

1. A process for preparing nanosized, thermally stable and high-surface-area multi component metal oxide materials, the said process comprising the steps:
i) dispersing two precursors of metal salts and a support metal oxide in a medium in a ratio in the range of 1:1: to 1:1:2;
ii) precipitating the dispersed precursor metal salts on to support metal oxide to obtain a precipitate, and
iii) calcinating the precipitate of step (ii) to obtain the multi-component nano sized metal oxide.

2. A process as claimed in claim 1, wherein said support metal oxide is selected from the group consisting of titania, silica, and alumina.

3. A process as claimed in claim 1, wherein said support metal oxide is in the form of fine powder which can give rise to high surface area and retain thermal stability.

4. A process as claimed in claim 1, wherein precursors metal salts are selected from the group consisting of cerium, zirconium, alkaline earth elements and mixtures thereof.

5. A process as claimed in claim 1, wherein precursor metal salts are selected from the group consisting of nitrates, chlorides, oxychlorides and mixtures thereof.

6. A process as claimed in claim 1, wherein in step (i) the medium is water.

7. A process as claimed in claim 1, wherein the precipitation of pre-cursor metal salts onto the said metal oxide support is carried out by increasing the pH at a temperature in the range of 293-3680 K.

8. A process as claimed in claim 7, wherein, the pH is raised to more than 10.5.

9. A process as claimed in claim 1, wherein the composite metal oxide materials retain surface area in excess of 50 m²/g after air-calcination for 6-8 hours at at least 1073° K.

10. A process as claimed in claim 1, wherein the metal oxide materials retain crystallite size up to the 5 nanometers after air-calcination for 6-8 hours at at least 1073° K.

11. A process as claimed in claim 1, wherein the multiple metal oxide material is further coated with noble metal/metal oxide.

12. A process as claimed in claim 11, wherein the coating of active metal/metal oxide is carried out by wetness impregnation of multiple metal oxide material in an aqueous solution of precursors of the active metal/metal oxide species which is selected from a group of active metals/metal oxides consisting, platinum, vanadium oxide, molybdenum oxide, and tungsten oxide.

13. A process as claimed in claim 12, wherein the wetness impregnation involves heating of the mixture of active metals/metal oxide with multiple metal oxide in aqueous solution of oxalic acid at a temperature in the range of 363-373° K., and subsequent calcination at a temperature in the range of 773-1073°K in air or oxygen atmosphere.

14. A process as claimed in claim 1, wherein the multicomponent metal oxide materials retain surface area in excess of 100 m²/g after calcination for 6-8 hours at at least 773° K.

15. A process as claimed in claim 1, wherein the multicomponent metal oxide materials retain crystallite size up to 5 nanometers after air-calcination for 6-8 hours at at least 773° K.
